(19) United States
(12) Patent Application Publication
(10) Pub. No.: US 2022/0414424 A1
(43) Pub. Date: Dec. 29, 2022

(54) COMMAND GENERATION APPARATUS, COMMAND GENERATION METHOD AND PROGRAM

(71) Applicant: Nippon Telegraph and Telephone Corporation, Tokyo (JP)

(72) Inventors: Hiroki IKEUCHI, Musashino-shi, Tokyo (JP); Keishiro WATANABE, Musashino-shi, Tokyo (JP)

(21) Appl. No.: 17/777,499

(22) PCT Filed: Nov. 21, 2019
(86) PCT No.: PCT/JP2019/045664

§ 371 Date: May 17, 2022

(51) Int. Cl. G06N 3/04; G06F 9/44

(52) U.S. Cl. CPC G06N 3/04; G06F 9/44

(57) ABSTRACT

A command generation device includes a relationship learning unit configured to learn a model showing an interactive relationship between a response of a computer system and a command executed for the computer system in response to the response, and a command generation unit configured to input, when a response newly output from the computer system is input, the response to the relationship to generate a command for a new response, so that a command for a response of the system can be generated.

### TECHNICAL FIELD

The present disclosure relates to a command generation device, a command generation method, and a program.

### BACKGROUND ART

In ICT systems that are becoming larger and more complex, the types and number of failures that are occurring are increasing. It is difficult to maintain high quality maintenance and operation with manual recovery measures being performed by an operator in the related art, and automation of recovery measures is desired.

Under these circumstances, the development of an automatic recovery system is underway. Typically, in an automatic recovery system, a preset scenario (execution of a specific command, or the like) is automatically executed with a specific log item or alarm (hereinafter simply referred to as a “log”) as a trigger, so that recovery is achieved without the intervention of an operator.

However, in many cases, there are barriers to the introduction of automatic recovery systems due to the prior labor of manual “trigger and scenario setting”. Setting a log as a trigger and setting a scenario at that case require a large number of operations by an operator with advanced know-how. Thus, manually creating scenarios for a wide variety of failures is a very expensive task, making it difficult to introduce an automatic recovery system.

For such a problem, a technology for automating work equivalent to “trigger and scenario setting” has been proposed.

NPL 1 proposes a technology for pre-learning, based on data of a log generated at the time of a past failure and recovery command executed at that time, a relationship between the log and the recovery command by using a neural network model called Seq2Seq, and automatically outputting a recovery command to be executed simply by inputting the generated log when a new failure has occurred. In this technology, work corresponding to “trigger and scenario setting” is replaced with Seq2Seq learning, which can be automatically executed simply by giving learning data, so that the above-described problem is solved. “A log to be focused on and a recovery command to be input at that time” are learned naturally by Seq2Seq, and it is not necessary to explicitly define these manually. When the recovery command output by the technology of NPL 1 is automatically executed, all the series of work from the occurrence of the failure to the recovery can be automated.

### CITATION LIST

### Non Patent Literature

NPL 1: Hiroki Ikeuchi, Akio Watanabe, Yoichi Matsuo, Takehiro Kawata, “Automatic generation of Failure Recovery Command Strings by Seq2Seq”, The Institute of Electronics, Information and Communication Engineers General Conference, B-7-25, 2019.

### SUMMARY OF THE INVENTION

### Technical Problem

In a scheme of NPL 1, a series of recovery commands that need to be executed until the recovery is completed are output at once based on an input log.

However, in actual recovery measures, there are many cases in which a command to be executed next is determined only after a system response to a command is obtained. For example, it is assumed that a normality confirmation tool that continues to input a ping to a specific node issues a log of “ping failure” and no other logs are obtained. In NPL 1, a recovery command is estimated only from this log, but in reality, it cannot be identified from this log alone whether a ping target node has failed or a node or link in a ping path has failed, and the recovery command cannot be specified. In such a case, a ping is input to another node or another status confirmation command is executed so that a system response (for example, “Ping passed to node A on a path to a ping target node”, this being also typically output as a log) is obtained and a next command is determined according to the system response. Thus, there are cases in which it is impossible to uniquely specify a series of recovery commands only with a log input at the beginning, and it is difficult to deal with such a failure using the technology of NPL 1.

Further, as a more complicated case, a case in which a command to be input next is determined based on not only an immediately preceding system response but also all system responses or execution commands over a plurality of previous steps is conceivable, and it is difficult to deal with such a case with the technology of NPL 1.

The present disclosure has been made in view of the above points, and an object of the present disclosure is to be able to generate a command for a response of a system.

### Means for Solving the Problem

Thus, in order to solve the above problem, a command generation device includes a relationship learning unit configured to learn a model showing an interactive relationship between a response of a computer system and a command executed for the computer system in response to the response, and a command generation unit configured to input, when new response output from the computer system is input, the new response to the relationship to generate a command for the new response.

### Effects of the Invention

It is possible to generate commands in response to system responses.

### BRIEF DESCRIPTION OF DRAWINGS

FIG. 1 illustrates an example of a system response and a command.

FIG. 2 is a diagram illustrating an overview of an HRED model used in the present embodiment.

FIG. 3 is a diagram illustrating a hardware configuration example of a command generation device 10 according to an embodiment of the present disclosure.

FIG. 4 is a diagram illustrating a functional configuration example of the command generation device 10 according to the embodiment of the present disclosure.

FIG. 5 is a diagram illustrating a part used in a learning phase.

FIG. 6 is a flowchart illustrating an example of a processing procedure that is executed by the command generation device 10 in the learning phase.

FIG. 7 is a diagram illustrating a part used in an inference phase.

FIG. 8 is a flowchart illustrating an example of a processing procedure that is executed by the command generation device 10 in the inference phase.

FIG. 9 is a diagram illustrating a process that is a failure insertion target in an experiment.

FIG. 10 is a diagram illustrating an example of learning data in the experiment.

FIG. 11 is a diagram illustrating evaluation results of the experiment.

FIG. 12 is a diagram illustrating a command representation method using a representation of an S-expression.

### DESCRIPTION OF EMBODIMENTS

Hereinafter, embodiments of the present disclosure will be described with reference to the drawings. The present embodiment includes a learning phase in which past data has been used, and an inference phase that operates when a computer system actually fails. First, learning data required in the learning phase will be described.

The learning data is a set of a pair of a system response (a response output from a computer system) and a command (a command executed for the computer system). Now, when N sets of these are given, the learning data can be expressed as D={(Xⁱ, Yⁱ)}ᵢ₌₁^{N}. Here,

Xⁱ=<X₁ⁱ,X₂ⁱ, . . . ,X_{|X}_{ⁱ}_{|}>,Yⁱ=<Y₁ⁱ,Y₂ⁱ, . . . ,Y_{|X}_{ⁱ}_{|}ⁱ> [Math. 1]

are a string of system responses and a string of commands Yⱼⁱ, respectively, and are obtained interactively or sequentially in chronological order as “generation of X₁ⁱ”→“execution of Y₁ⁱ”→“generation of X₂ⁱ”→ . . . →“execution of Y_{|Xi|-1}ⁱ”→“generation of X_{|Xi|}ⁱ”→“execution of Y_{|Xi|}ⁱ”.

Further, the system response and the command are

Xⱼⁱ=<x_{j,1}ⁱ,x_{j,2}ⁱ, . . . ,x_{j,|x}_{ⱼ}_{ⁱ}_{|}>,Yⱼⁱ=<y_{j,1}ⁱ,y_{j,2}ⁱ, . . . ,y_{j,|x}_{ⱼ}_{ⁱ}_{|}> [Math. 2]

expressed as a string of a word x_{j,k}ⁱ ε V_{X} and word y_{j,k}ⁱ ε V_{Y}.

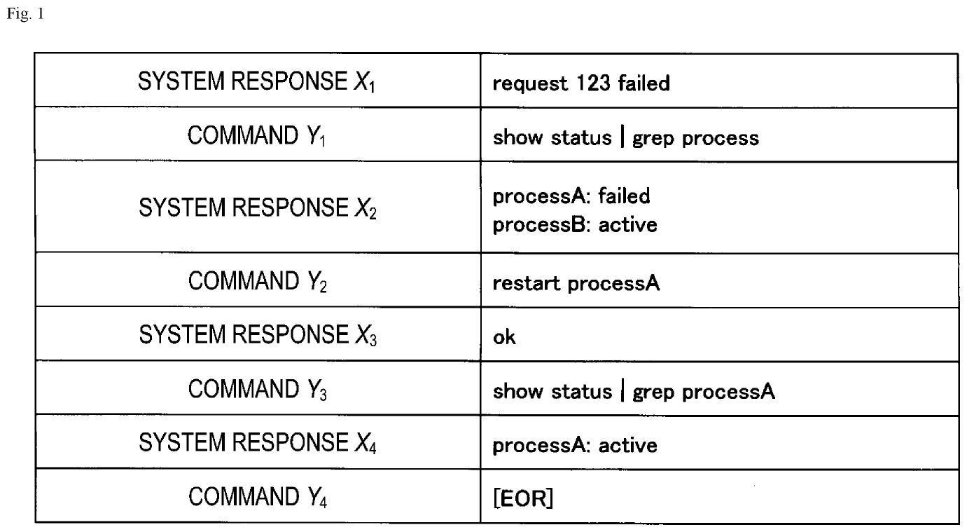

Here, V_{X} is a set of all words that can appear in a system response, and V_{Y} is a set of all words that can appear in a command. As an example, FIG. 1 illustrates an example of a system response and a command. As illustrated in FIG. 1, X₁ⁱ is not a system response to a command, but a log that triggers to start recovery measures (or simply a token indicating the start of recovery work), and Y_{|Xi|}ⁱ may not be a command, but a special token [EOR] (end of recovery) that indicates that the recovery has completed.

Although the system response or the command as raw data is illustrated in FIG. 1, the learning data is D and has a format as a specific example of a system response X₂ and a command Y₃ shown below.
X₂=<process A:, failed, _n_, process B:, active, [EOS]>
Y₃=<show, status, |, grep, process A, [Enter]>

Here, _n_ represents a line feed, [EOS] represents a termination token (end of sentence) of the system response, [Enter] represents pressing of an enter key, and each of these is also counted as one word.

Next, recovery measures in the present embodiment, that is, the inference phase will be formally described. In the present embodiment, an estimator f is generated from learning data D in the learning phase. In the inference phase, recovery measures are performed using this estimator f as follows.

When a new failure occurs and a system response X₁^{test} is obtained, f is used to estimate a command as

Ŷ₁=f(X₁^{test}) [Math. 3]

and the estimated command is executed for a system that is a recovery target. As a result, when X₂^{test} is obtained to be the system response, a next command is estimated and executed as follows.

Ŷ₂=f(X₂^{test}) [Math. 4]

Repeating this process until the system is recovered is recovery measures in which the present embodiment has been used. Thus, how to construct f for success of the recovery measures is a main part of the present embodiment.

In the present embodiment, the system response and the command are regarded as a “dialogue” between two parties, a dialogue system is constructed, and this dialogue system is used as the estimator f That is, in a typical dialogue system, a “model” is learned based on a large amount of conversation logs of speaker A and speaker B over a plurality of turns, and an utterance of speaker B is automatically generated when an utterance of speaker A is given, whereas in the present embodiment, the system response is assumed as an utterance of the speaker A, and the command is assumed as an utterance of the speaker B. Hereinafter, an example in which a hierarchical recurrent encoder decoder (HRED) (“Sordoni, Alessandro, et al. “A hierarchical recurrent encoder-decoder for generative context-aware query suggestion”. Proceedings of the 24th ACM International on Conference on Information and Knowledge Management. ACM, 2015.”) is used as a model for implementing a dialogue system will be described, but a model other than such a model may be used.

HRED is one of the neural network models and is divided into a learning phase and an inference phase. This directly corresponds to the learning phase and the inference phase of the present embodiment described above.

First, it will be briefly described what kind of processing is executed internally during the inference phase, that is, when a command is estimated with a learned HRED.

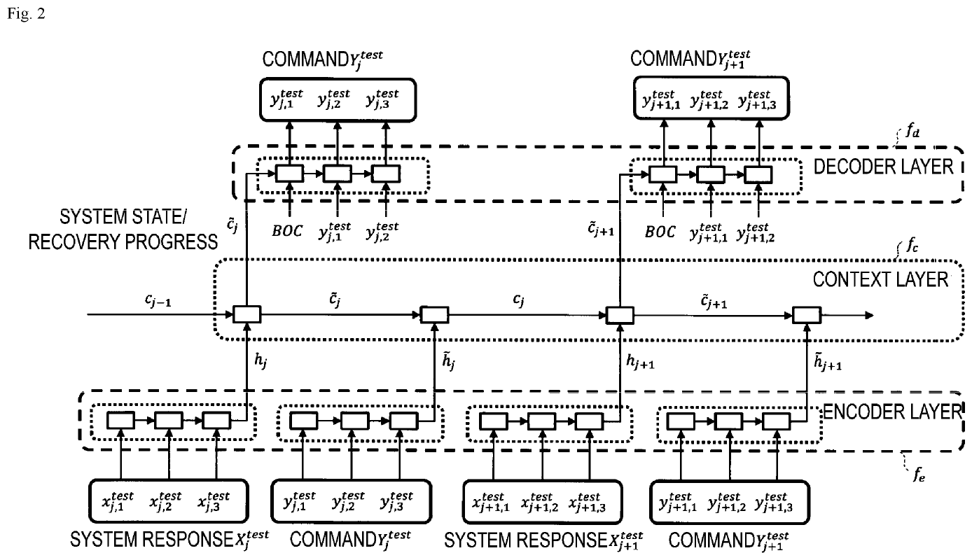

FIG. 2 is a diagram illustrating an overview of the HRED model used in the present embodiment. The HRED includes three major components including an encoder layer fₑ, a context layer f_{c}, and a decoder layer f_{d}. When recovery measures are performed, the following (1) to (6) are repeated while incrementing j as j=1, 2, . . . , |X^{test}|. However, |X^{test}| (the number of elements of X^{test}) is not known from the beginning, and the recovery measures end when a system response indicates recovery complete (presents a thing equivalent to <EOR>).

(1) A system response Xⱼ^{test} is input to an encoder layer fₑ, and a hidden vector hⱼ is output: hⱼ=fₑ(Xⱼ^{test}).

(2) A context layer G outputs a new context vector c^{˜}ⱼ from a context vector cⱼ₋₁ (will be defined recursively in (6)) and the hidden vector hⱼ: c^{˜}ⱼ=f_{c}(hⱼ, cⱼ₋₁). Here, c^{˜} represents a symbol in which ˜ is added above c in FIG. 2.

(3) The decoder layer f_{d} outputs Yⱼ^{test} based on the context vector c^{˜}ⱼ: Yⱼ^{test}=f_{d}(c^{˜}ⱼ).

(4) The output Yⱼ^{test} is input to the system that is a recovery target, and a system response Xⱼ₊₁^{test} is acquired.

(5) Yⱼ^{test} is input to the encoder layer fₑ and converted into a hidden vector h^{˜}ⱼ: h^{˜}ⱼ=fₑ(Yⱼ^{test}). Here, h^{˜} represents a symbol in which ˜ is added above h in FIG. 2.

(6) The context layer outputs a new context vector from the context vector c^{˜}ⱼ and the hidden vector h^{˜}ⱼ: cⱼ=f_{c}(h^{˜}ⱼ, c^{˜}ⱼ). This is provided that c₀ is a zero vector.

The above calculations are repeated from (1) with a value of j incremented by 1. Typically, all of fₑ, f_{c}, and f_{d} are implemented by a recurrent neural network (RNN) or variants thereof (long short-term memory (LSTM) or gated recurrent unit (GRU)).

A point of use of the HRED model in the present embodiment is that the context vector cⱼ can be propagated. Past exchanges, that is, system responses output in the past (<C₁^{test}, X₂^{test}, . . . , Xⱼ^{test}>) and commands input in the past (<Y₁^{test}, Y₂^{test}, . . . , Yⱼ^{test}>) are aggregated in a hidden vector cⱼ, and in that sense, cⱼ can be considered as a vector that abstractly represents a system state during recovery or the progress of the recovery. Based on such cⱼ, a command Yⱼ₊₁^{test} to be input next is determined together with the latest system response Xⱼ₊₁^{test}.

In the scheme of NPL 1, because the context layer f_{c} does not present and the encoder layer fₑ and the decoder layer f_{d} are directly connected (in other words, a model of only j=1), it is not possible to take past “context” into account or generate commands interactively.

In the learning phase of the model of the present embodiment, a log-likelihood maximization is performed using learning data D={(Xⁱ, Yⁱ)}ᵢ₌₁^{N}, as in learning of a normal neural network model. Thus, weight parameters of the encoder layer fₑ, the context layer f_{c}, and the decoder layer f_{d} are acquired.

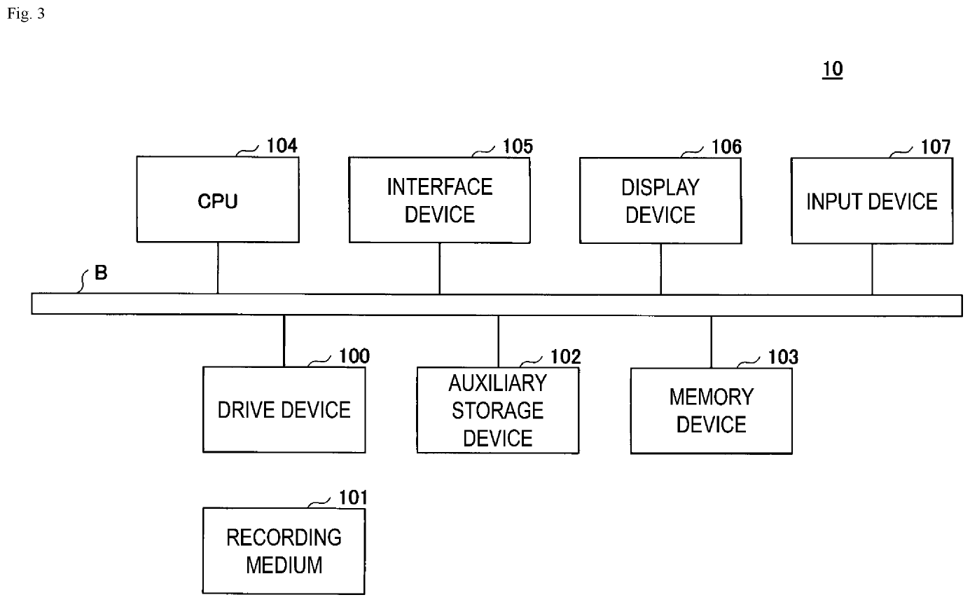

Hereinafter, the command generation device 10 that achieves the above content will be specifically described. FIG. 3 is a diagram illustrating a hardware configuration example of the command generation device 10 according to the embodiment of the present disclosure. The command generation device 10 of FIG. 3 includes a drive device 100, an auxiliary storage device 102, a memory device 103, a CPU 104, an interface device 105, a display device 106, an input device 107, and the like, which are connected to each other by a bus B.

A program that implements processing in the command generation device 10 is provided by a recording medium 101 such as a CD-ROM. When the recording medium 101 storing the program is set in the drive device 100, the program is installed in the auxiliary storage device 102 from the recording medium 101 via the drive device 100. However, the program does not necessarily have to be installed from the recording medium 101, and may be downloaded from another computer via a network. The auxiliary storage device 102 stores the installed program and also stores necessary files, data, and the like.

The memory device 103 reads and stores the program from the auxiliary storage device 102 when the program is instructed to start. The CPU 104 implements functions related to the command generation device 10 according to the program stored in the memory device 103. The interface device 105 is used as an interface for connection to a network. The display device 106 displays a graphical user interface (GUI) according to a program or the like. The input device 107 is configured of a keyboard, a mouse, and the like, and is used for inputting of various operation instructions.

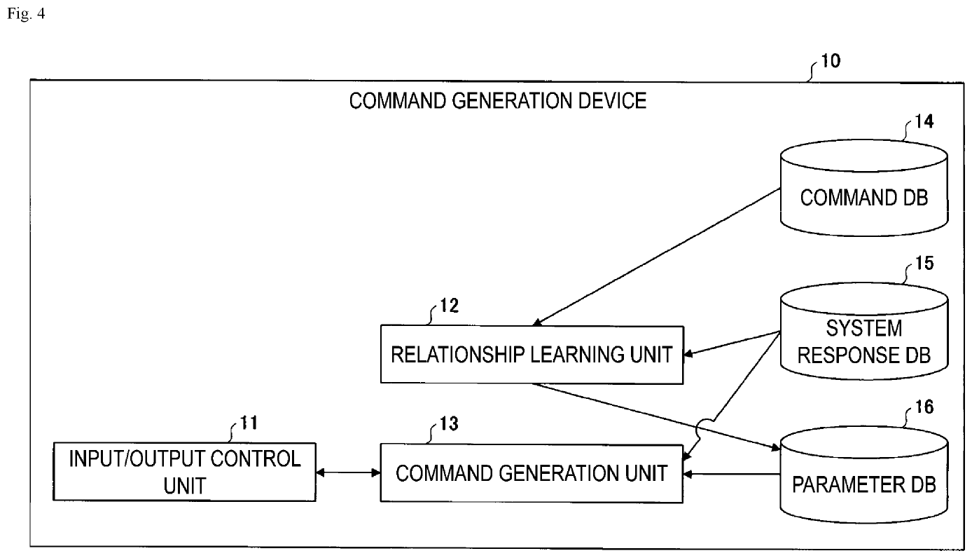

FIG. 4 is a diagram illustrating a functional configuration example of the command generation device 10 according to the embodiment of the present disclosure. In FIG. 4, the command generation device 10 includes an input control unit 11, a relationship learning unit 12, and a command generation unit 13. The respective units are implemented by processing operations of causing the CPU 104 to execute one or more programs installed in the command generation device 10. The command generation device 10 also uses a database (storage unit) such as a command DB 14, a system response DB 15, and a parameter DB 16. Each of these databases (each storage unit) can be implemented by using, for example, a storage device that can be connected to the auxiliary storage device 102 or the command generation device 10 via a network.

The input control unit 11 controls an input from a user, an output to the user, and the like. The system response DB 15 accumulates (stores) a log of system responses at the time of a past system failure. The command DB 14 accumulates (stores) a log of commands executed at the time of a past system failure. That is, the above-described learning data D={(Xⁱ, Yⁱ)}ᵢ₌₁^{N} is stored in the system response DB 15 and the command DB 14.

The relationship learning unit 12 learns an interactive relationship (HRED model) from the system response and the command corresponding to the system response. The parameter DB 16 stores information (parameters) indicating the relationship learned by the relationship learning unit 12. When a new system response is given, the command generation unit 13 sequentially generates and outputs commands corresponding to the system response based on the learned relationship (HRED model).

A “dictionary” in which a word ID is associated with a word on a one-to-one basis may be defined in each of the system response DB 15 and the command DB 14, and a series of system responses or a series of commands may be held in the form of a word ID string.

As described above, the processing executed by the command generation device 10 includes a learning phase in which a relationship between the system response and the command is learned in advance, and an inference phase in which commands corresponding to the system response newly given are sequentially generated from the relationship between the pieces of data stored in the learning phase.

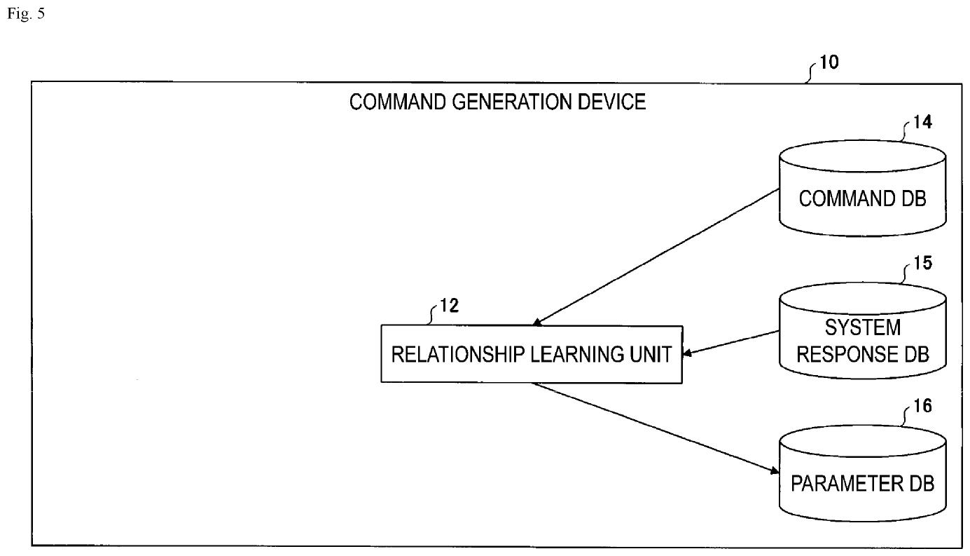

FIG. 5 is a diagram illustrating a part used in the learning phase. FIG. 5 illustrates only the part used in the learning phase in FIG. 4.

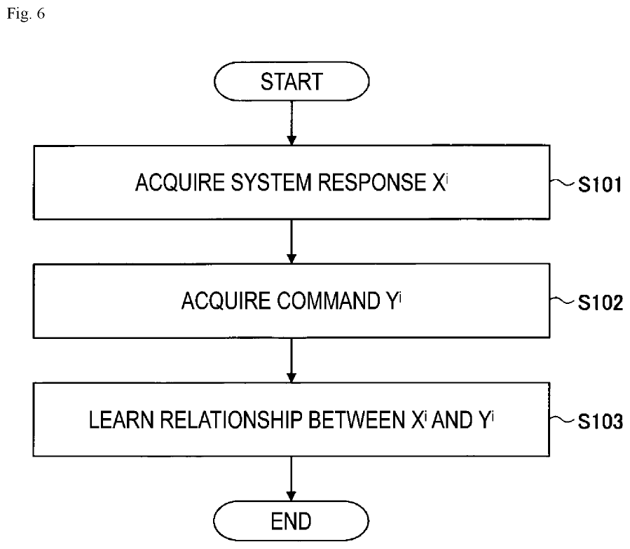

FIG. 6 is a flowchart illustrating an example of a processing procedure that is executed by the command generation device 10 in the learning phase.

In step S101, the relationship learning unit 12 acquires a system response Xⁱ from the system response DB 15. System logs, alarms, standard/error outputs for a command, and the like are accumulated as the system response Xⁱ in chronological order in the system response DB 15.

Subsequently, the relationship learning unit 12 acquires a command Yⁱ from the command DB 14 (S102). Strings in which a series of commands Yⁱ is divided for each word is accumulated in chronological order in the command DB 14.

Subsequently, the relationship learning unit 12 learns a relationship between the system response Xⁱ and the command Yⁱ as a parameter of a function as the estimator f, and accumulates learning results in the parameter DB 16 (S103). For example, when the above-described HRED is used as the command generation unit 13, because a function (estimator f) thereof is composed of a neural network, weight parameters thereof (that is, weight parameters of the encoder layer fₑ, the context layer f_{c}, and the decoder layer f_{d}) are accumulated.

A processing procedure of FIG. 6 is executed for i=1 to N.

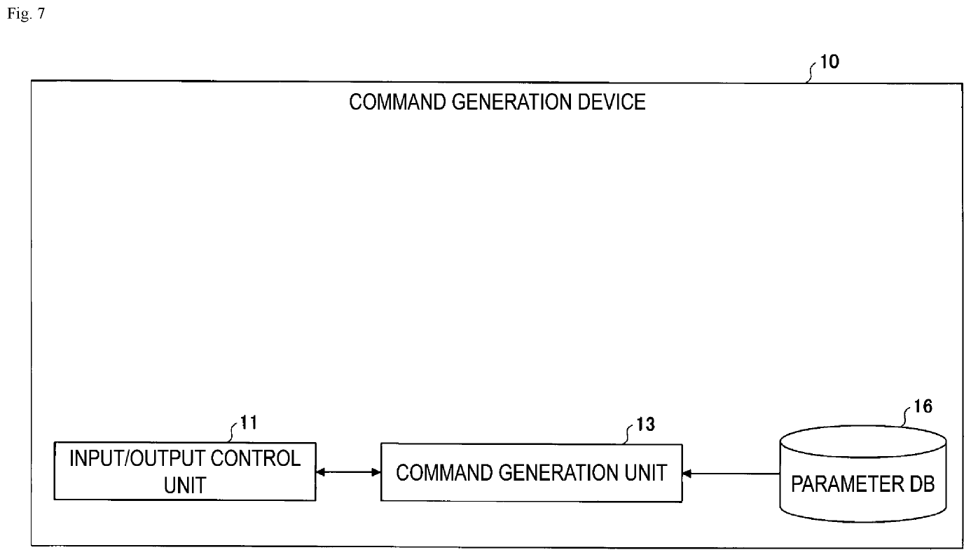

FIG. 7 is a diagram illustrating a part used in the inference phase. In FIG. 7, only the part used in the inference phase in FIG. 4 is illustrated.

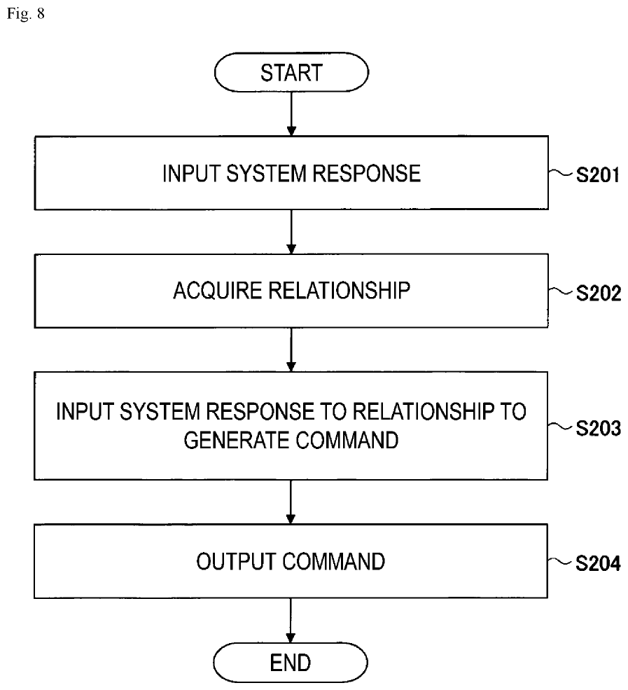

FIG. 8 is a flowchart illustrating an example of a processing procedure that is executed by the command generation device 10 in the inference phase.

In step S201, the command generation unit 13 acquires one system response Y^{test} newly input via the input control unit 11 at the time of operation. Subsequently, the command generation unit 13 acquires parameters of a function (estimator f) indicating a relationship between the system response and the command from the parameter DB 16 (S202). Subsequently, the command generation unit 13 inputs the system response Y^{test} to the function (estimator f) to which the parameter has been applied, to generate one command X^{test} (S203). Subsequently, the command generation unit 13 sequentially outputs the command X^{test} (S204).

As described above, according to the present embodiment, it is possible to generate a command for a response of the system. That is, according to the present embodiment, a dialogue system (estimator f) composed of a command and a system response is learned with a series of commands executed until recovery and a log of system responses corresponding to the commands as learning data, and when a new failure occurs, it is possible to sequentially estimate and output commands to be executed. In particular, when the command to be input next depends on past exchanges of commands and system responses, it is impossible to generate the command in an existing technology, whereas according to the present embodiment, even such a failure can be an automatic recovery target because automatic command generation is possible, and it is possible to contribute to a significant reduction in a burden of system operation.

For example, an example of a ping command is as follows. When a ping failure log is obtained to be a result of a normality confirmation tool executing the ping command, the ping failure log is input to the command generation device 10 so that the command generation device 10 estimates a command to be input (a command for isolating a failure location/cause, a command for removing a specified failure cause and performing recovery, a command for immediately recovering a service through system switching, or the like). When the system response obtained by the command is input to the command generation device 10 again, the command generation device 10 further estimates the command to be input next. These procedures are repeated until the system is recovered. Automatic recovery can be achieved by automating the input of the system response to the command generation device 10 and the execution of the command estimated by the command generation device 10 according to the operation of the command generation device 10.

Hereinafter, results of an experiment actually performed in a verification environment using the command generation device 10 of the present embodiment will be described. For verification, a cloud system was constructed with OpenStack, which is a cloud platform of open source software (OSS), and experiments were performed.

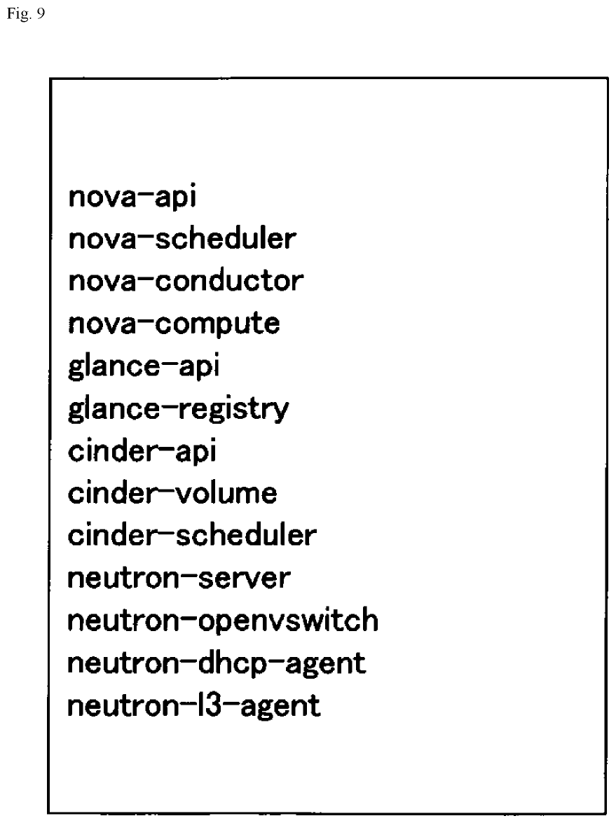

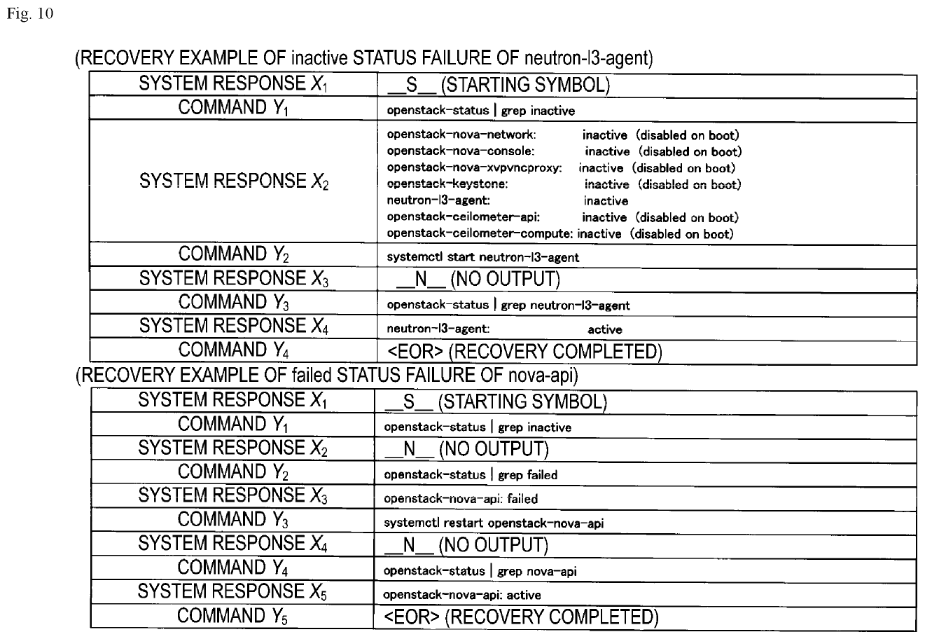

As failures, a total of 26 failures including 13 types of failures caused by putting each one type of process that is mutually different among the 13 types of processes illustrated in FIG. 9 into an inactive status and 13 types of failures caused by putting each one type of process that is mutually different among the 13 types of processes illustrated in FIG. 9 into a failed status were considered and artificially caused. A series of commands and system responses for recovery from such a failure were recorded, and a total of 1300 pairs of learning data were obtained (because the system responses slightly differ or there are a plurality of patterns of recovery commands for the same failure, there is a variation in the learning data). An example of the learning data is illustrated in FIG. 10. In FIG. 10, an upper table shows a history of the system responses and the commands until the recovery for a failure in which neutron-13-agent is set to an inactive status among the 13 types of processes. A lower table shows a history of the system responses and the commands until the recovery for a failure in which nova-api is set to a failed status among the 13 types of processes. When the HRED model is learned, “no output (_N_)”, “line feed”, “pressing of enter key”, “recovery completed ([EOR])”, and the like are also treated as one word. After learning of the model ended, a failure was generated again, the system response was input to the learned model, and whether a correct command continued to be output until recovery (whether to reach the completion of recovery) was evaluated for each of 26 types of failures.

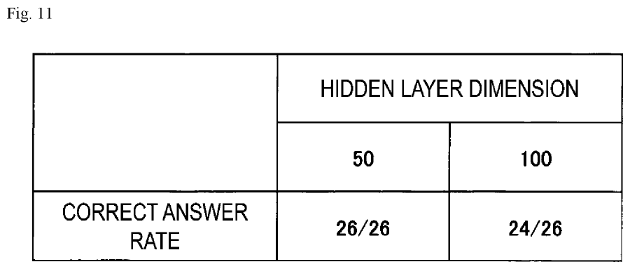

FIG. 11 is a diagram illustrating evaluation results of an experiment. The experiment was performed for two patterns in which a hidden layer dimension, which is a hyperparameter of the HRED model, was set to 50 and 100. FIG. 11 illustrates a correct answer rate for each pattern. The correct answer rate indicates the number of cases that reached the completion of recovery among 26 types of failures. According to FIG. 11, it can be seen that the recovery can be completed with high accuracy in each case.

As described above, according to the present embodiment, it is possible to sequentially generate commands for system responses. For example, it is possible to automatically and sequentially generate commands in consideration of all past series of system responses and executed commands for a failure for which the recovery command cannot always be specified only with a log obtained at the beginning and it is necessary to take sequential coping steps of executing commands, acquiring the system response to the commands, and determining commands to be executed next.

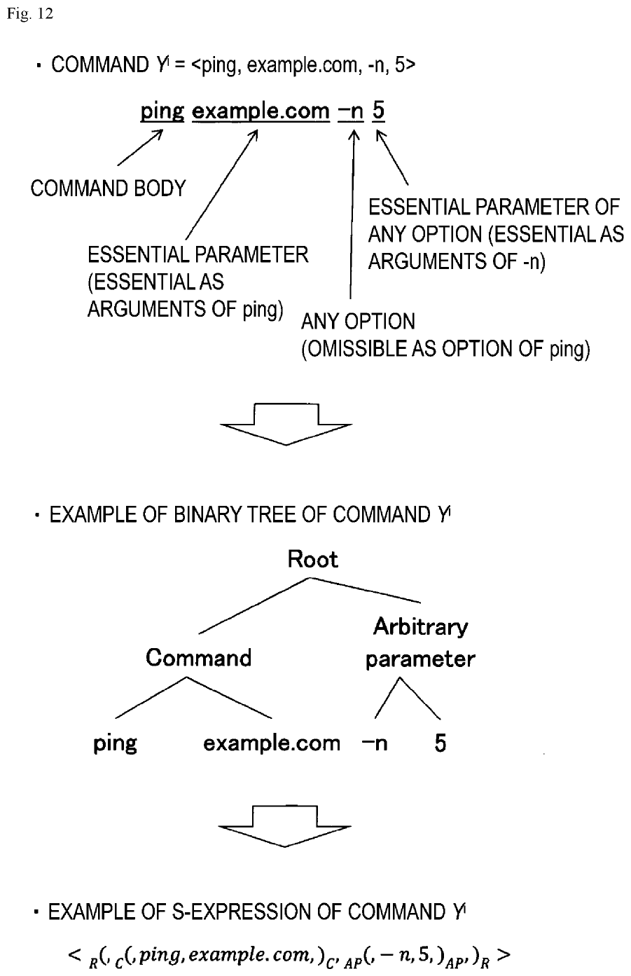

In the present embodiment, an example in which the output command is simply treated as a word string Yⁱ=−Y₁ⁱ, Y₂ⁱ, . . . , Y_{|Xi|}ⁱ> is shown, but other examples may be applied. For example, a command normally has strict syntactic constraints, and deviation from a syntax is not tolerated even when a mistake is small. As a method of considering such syntactic constraints, a method of treating a command as a parenthesized word string using a representation of an S-expression for reflecting a grammatical structure of a natural language (“Roee Aharoni and Yoav Goldberg, “Towards String-To-Tree Neural Machine Translation”. Proceedings of the 55th Annual Meeting of the Association for Computational Linguistics (Volume 2: Short Papers), 2017.”) can be considered. In the parenthesized word string, a command is represented in a binary tree structure in which syntax constraints have been reflected, and then converted into a word string with parentheses, and described. There is no general theory for converting a command into the representation of the S-expression, but for example, the conversion may be performed using an appropriate rule defined as illustrated in FIG. 12. In an example of an S-expression of a command Yⁱ illustrated in FIG. 12, parentheses such as “c(“or”)_{AP}” are added in addition to a normal word so that syntax information is reflected in a word string. Data is converted into such a format and then the neural network model of the present embodiment is trained, so that it can be expected to naturally acquire the properties (syntax and constraints) that, for example, at least one parameter is required to complete a certain command (for example, a ping command), for example, any options and parameters thereof are required between “_{AP}(“and”)_{AP}”, a certain option must be paired with another option, and the like. Thus, a method of devising a data format without changing the model itself of the present embodiment does not always guarantee that estimation results satisfy the syntactic constraints, but it is conceivable that accuracy thereof becomes high.

Although the embodiments of the present disclosure have been described in detail above, the present disclosure is not limited to such specific embodiments, and various modifications and change can be made within the scope of the gist of the present disclosure described in the aspects.

### REFERENCE SIGNS LIST

10 Command generation device

11 Input control unit

12 Relationship learning unit

13 Command generation unit

14 Command DB

15 System response DB

16 Parameter DB

100 Drive device

101 Recording medium

102 Auxiliary storage device

103 Memory device

104 CPU

105 Interface device

106 Display device

107 Input device

B Bus

1. A command generation device comprising:
a relationship learning unit, including one or more processors, configured to learn a model showing an interactive relationship between a response of a computer system and a command executed for the computer system in response to the response; and
a command generation unit, including one or more processors, configured to input, when new response output from the computer system is input, the new response to the relationship to generate a command for the new response.

2. The command generation device according to claim 1, wherein the model is a recurrent neural network.

3. The command generation device according to claim 1, wherein the model is a hierarchical recurrent encoder decoder (HRED).

4. A command generation method comprising:
learning, by a computer, a model showing an interactive relationship between a response of a computer system and a command executed for the computer system in response to the response; and
inputting, by the computer, when new response output from the computer system is input, the new response to the relationship to generate a command for the new response.

5. The command generation method according to claim 4, wherein the model is a recurrent neural network.

6. The command generation method according to claim 4 or 5, wherein the model is a hierarchical recurrent encoder decoder (HIRED).

7. A non-transitory computer readable medium storing one or more instructions causing a computer to execute:
learning a model showing an interactive relationship between a response of a computer system and a command executed for the computer system in response to the response; and
inputting when new response output from the computer system is input, the new response to the relationship to generate a command for the new response.

8. The non-transitory computer readable medium according to claim 7, wherein the model is a recurrent neural network.

9. The non-transitory computer readable medium according to claim 7, wherein the model is a hierarchical recurrent encoder decoder (HIRED).
